(19) United States
(12) Patent Application Publication
(10) Pub. No.: US 2025/0310045 A1
(43) Pub. Date: Oct. 2, 2025

(54) TECHNIQUES FOR CONFIGURING TRANSMISSION CONFIGURATION INDICATOR (TCI) STATES FOR MULTIPLE TRANSMISSION/RECEPTION POINTS

(71) Applicant: QUALCOMM Incorporated, San Diego, CA (US)

(72) Inventors: Jae Ho RYU, San Diego, CA (US); Mostafa KHOSHNEVISAN, San Diego, CA (US); Yan ZHOU, San Diego, CA (US); Jing DAI, Beijing (CN)

(21) Appl. No.: 18/864,345

(22) PCT Filed: Jul. 11, 2022
(86) PCT No.: PCT/CN2022/104811

§ 371 Date: Nov. 8, 2024

(51) Int. Cl. H04L 5/00; H04B 7/024; H04B 7/06

(52) U.S. Cl. CPC H04L 5/0035; H04B 7/024; H04B 7/0628

(57) ABSTRACT

Aspects described herein relate to a user equipment (UE) or other device receiving, based on a maximum number of transmission configuration indicator (TCI) states, an indication of one or more TCI states for coherent joint transmission (CJT) from at least a portion of multiple transmission/reception points (TRPs) that can be configured for the UE. One or more downlink reference signals can be received based on the indication and from at least the portion of the multiple TRPs, and a power delay profile (PDP) or Doppler spectrum for channel estimation for at least a portion of the one or more TCI states can be derived based on the one or more downlink reference signals. Other aspects relate to transmitting the indication of the TCI states and/or the reference signals.

### CLAIM OF PRIORITY UNDER 35 U.S.C. § 119

This application is a 35 U.S.C. § 371 National Stage of PCT Application No. PCT/CN2022/104811, filed on Jul. 11, 2022, entitled “TECHNIQUES FOR CONFIGURING TRANSMISSION CONFIGURATION INDICATOR (TCI) STATES FOR MULTIPLE TRANSMISSION/RECEPTION POINTS,” which is assigned to the assignee hereof, and incorporated herein by reference in its entirety.

### FIELD OF THE DISCLOSURE

Aspects of the present disclosure relate generally to wireless communication systems, and more particularly, to techniques for configuring transmission configuration indicator (TCI) states.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, such as 5G NR, a network node can configure transmission configuration indicator (TCI) states to facilitate quasi co-location (QCL) association between reference signals for channel estimation. A UE can receive the configuration of the TCI states, and can receive an activation of a TCI state from the configuration for performing channel estimation of certain downlink data signals. In addition, in 5G NR, a UE can be configured to receive downlink signals from multiple transmission/reception points (TRPs) using coherent joint transmission (CJT).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a processor, memory coupled with the processor, and instructions stored in the memory. The instructions are operable, when executed by the processor, cause the apparatus to transmit, to a network node, a user equipment (UE) capability indicating a maximum number of active transmission configuration indicator (TCI) states supported for coherent joint transmission (CJT) from multiple transmission reception points (TRPs), receive, from the network node and based on the maximum number of TCI states, an indication of one or more TCI states for CJT from at least a portion of the multiple TRPs, receive, based on the indication and from at least the portion of the multiple TRPs, one or more downlink reference signals, and derive, based on the one or more downlink reference signals, a power delay profile (PDP) or Doppler spectrum for channel estimation for at least a portion of the one or more TCI states.

In another aspect, an apparatus for wireless communication is provided that includes a processor, memory coupled with the processor, and instructions stored in the memory. The instructions are operable, when executed by the processor, cause the apparatus to receive, for a UE, a UE capability indicating a maximum number of active TCI states supported for CJT from multiple TRPs, transmit, to the UE and based on the maximum number of TCI states, an indication of one or more TCI states for CJT from at least a portion of the multiple TRPs, and transmit, based on the indication and from at least the portion of the multiple TRPs, one or more downlink reference signals.

In another aspect, a method for wireless communication at a UE is provided that includes transmitting, to a network node, a UE capability indicating a maximum number of active TCI states supported for CJT from multiple TRPs, receiving, from the network node and based on the maximum number of TCI states, an indication of one or more TCI states for CJT from at least a portion of the multiple TRPs, receiving, based on the indication and from at least the portion of the multiple TRPs, one or more downlink reference signals, and deriving, based on the one or more downlink reference signals, a PDP or Doppler spectrum for channel estimation for at least a portion of the one or more TCI states.

In another aspect, a method for wireless communication at a network node is provided that includes receiving, for a UE, a UE capability indicating a maximum number of active TCI states supported for CJT from multiple TRPs, transmitting, to the UE and based on the maximum number of TCI states, an indication of one or more TCI states for CJT from at least a portion of the multiple TRPs, and transmitting, based on the indication and from at least the portion of the multiple TRPs, one or more downlink reference signals.

In a further example, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for using or managing a configuration of a number of transmission configuration indicator (TCI) states for coherent joint transmission (CJT) from multiple transmission/reception points (TRPs), in accordance with aspects described herein;

FIG. 6 is a flow chart illustrating an example of a method for configuring a UE for using or managing a configuration of a number of TCI states for CJT from multiple TRPs, in accordance with aspects described herein;

FIG. 7 illustrates examples of examples of power delay profile (PDP) spectrums derived for various TRP or TCI state configurations, in accordance with aspects described herein; and

FIG. 8 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to configuring transmission configuration indicator (TCI) states for communications with multiple transmission/reception points (TRPs). In some wireless communication technologies, such as fifth generation (5G) new radio (NR), devices, such as user equipment (UEs), can be configured to communicate with multiple TRPs (e.g., up to four TRPs in some examples). For example, the UEs can be configured to receive a downlink transmission (e.g., a physical downlink shared channel (PDSCH) transmission) from the multiple TRPs, where the multiple TRPs can transmit the downlink transmission using coherent joint transmission (CJT). In an example, enhancements of channel state information (CSI) acquisition of CJT (e.g., targeting one or more frequency ranges (FRs), such as FRI in 5G NR) and up to four TRPs can be specified, assuming ideal backhaul and synchronization as well as same number of antenna ports across TRPs. In an example, CJT can imply that a demodulation reference signal (DMRS) port for PDSCH is transmitted from multiple TRPs according to cross-TRP precoding. A subset of TRPs for PDSCH CJT transmission can be selected dynamically from up to a certain number of TRPs (e.g., 4 TRPs) according to CSI feedback in frequency division duplexing (FDD) or sounding reference signal (SRS) measurement in time division duplexing (TDD). Accordingly, in some examples, TCI indication and corresponding UE loop operation may lead to large burden on UE's tracking loop implementation based on tracking various TCI states for various TRP configurations.

Accordingly, aspects described herein relate to reducing a number of TCI states configured for the UE given the possible multiple TRP configurations. The UE can derive a power delay profile (PDP) or Doppler spectrum for channel estimation based on the reduced number of TCI states configured for the UE. For example, the network node can select and indicate one or more TCI states from the reduced number of TCI states for a selected number of TRPs. This can reduce the processing required by the UE to manage the TCI state loop, the amount of signaling necessary to update the TCI state loop for each of the TCI states, etc. This can, in turn, improve performance of the UE, conserve signaling resources and communications between the UE and a network node, etc. This improvement in performance can enhance user experience when using the UE, battery life of the UE, etc.

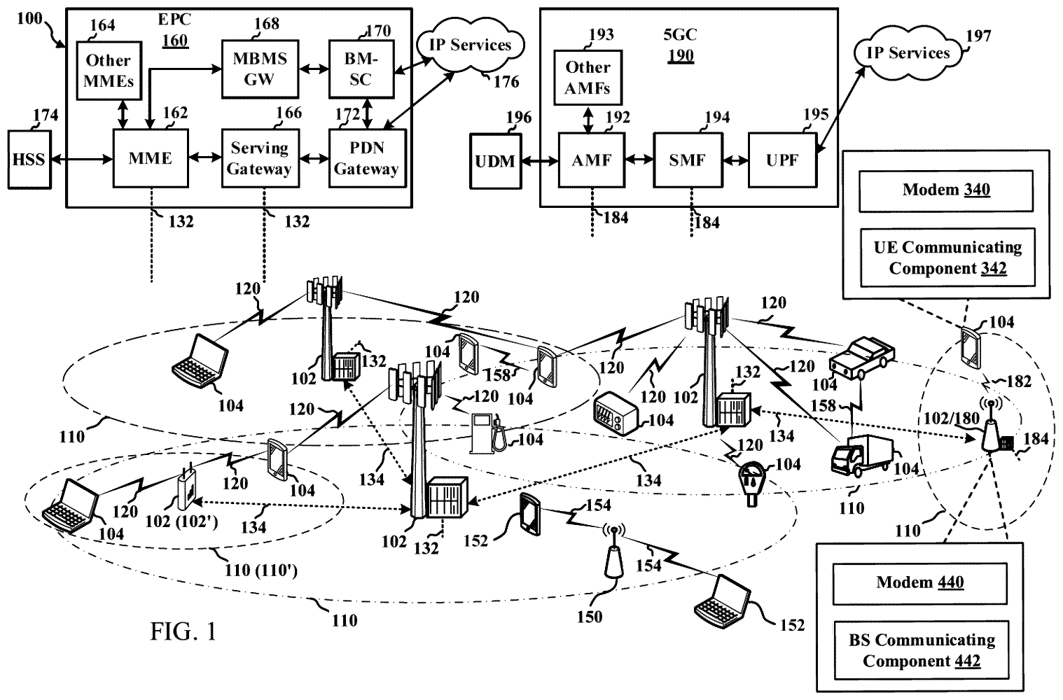

The described features will be presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for managing configuration of number of TCI states, up to a maximum number, for CJT using multiple TRPs, in accordance with aspects described herein. In addition, some nodes may have a modem 440 and BS communicating component 442 for configuring a UE with a number of TCI states, up to a maximum number, for CJT using multiple TRPs, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 can receive, e.g., from a BS communicating component 442 of a network node, an indication of one or more TCI states that are for CJT based on at least a portion of multiple TRPs. The indication can be based on a maximum number of active TCI states that are supported for CJT, which may be at least one of indicated by the UE communicating component 342, based on a wireless communication technology standard or otherwise stored in a memory of the UE 104, etc. In addition, in an example, UE communicating component 342 can receive, e.g., from a BS communicating component 442 of a network node, a configuration of a reduced number of TCI states (e.g. up to the maximum number of active TCI states supported for CJT), and BS communicating component 442 can indicate the indication of the one or more TCI states from the configuration based on a selected number of configuration of TRPs. UE communicating component 342, in an example, can receive, e.g., from the BS communicating component 442, one or more reference signals, and can derive the PDP or Doppler spectrum for at least a portion of the one or more TCI states based on the one or more reference signals.

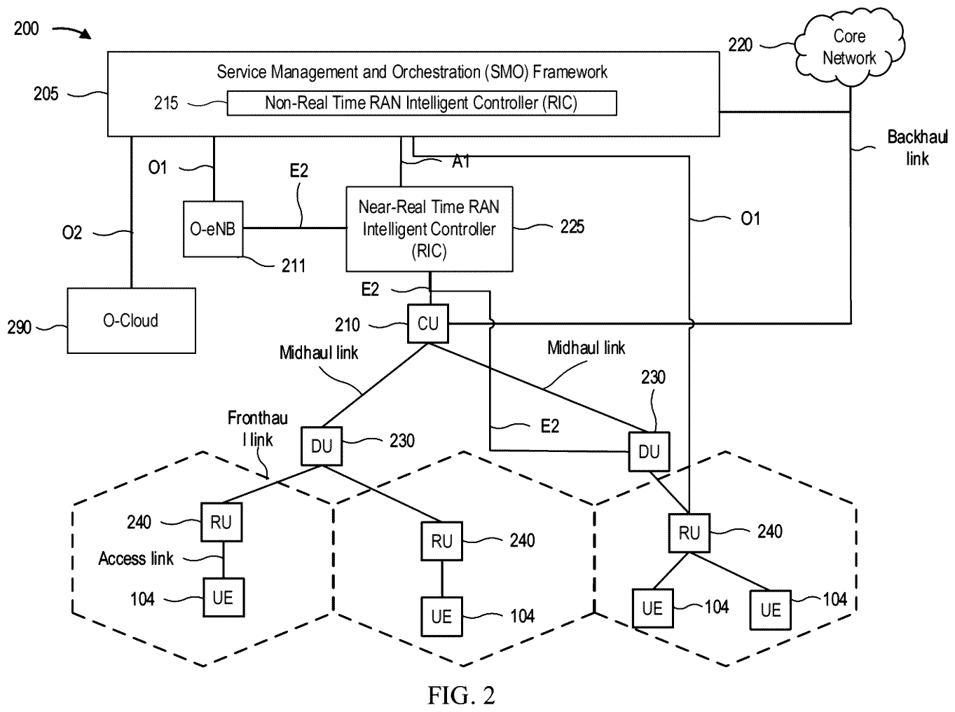

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In an example, BS communicating component 442, as described herein, can be at least partially implemented within a CU 210, and can transmit the one or more alignment parameters to one or more DUs 230. In this example, the one or more DUs 230 can configure the UE 104 with the alignment parameters for receiving the transmission burst in CDRX mode. In another example, BS communicating component 442, as described herein, can be at least partially implemented within a DU 230, and can transmit the one or more alignment parameters to one or more RUs 240. In this example, the one or more RUs 240 can configure the UE 104 with the alignment parameters for receiving the transmission burst in CDRX mode.

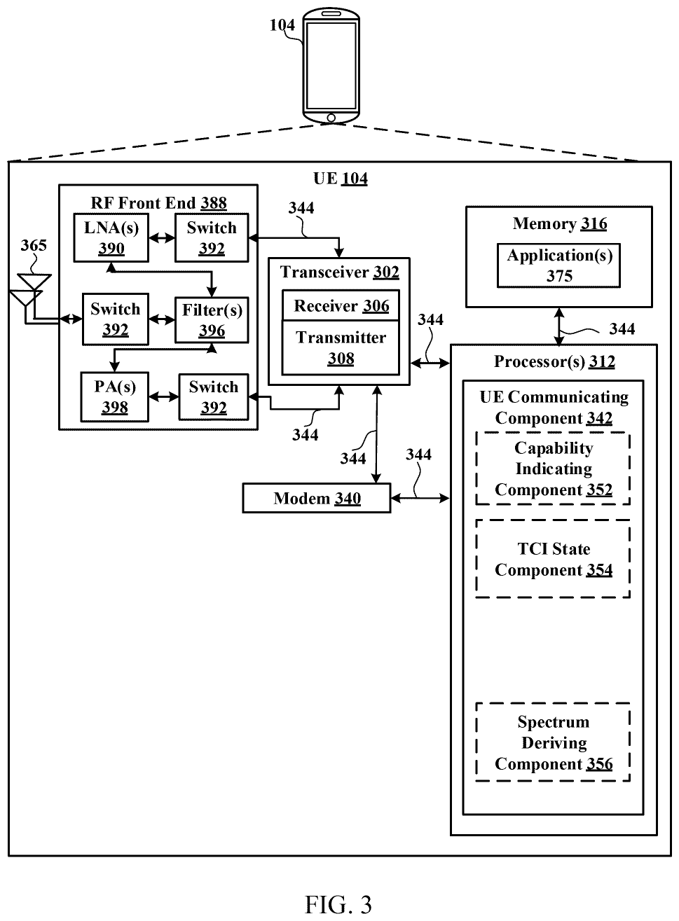

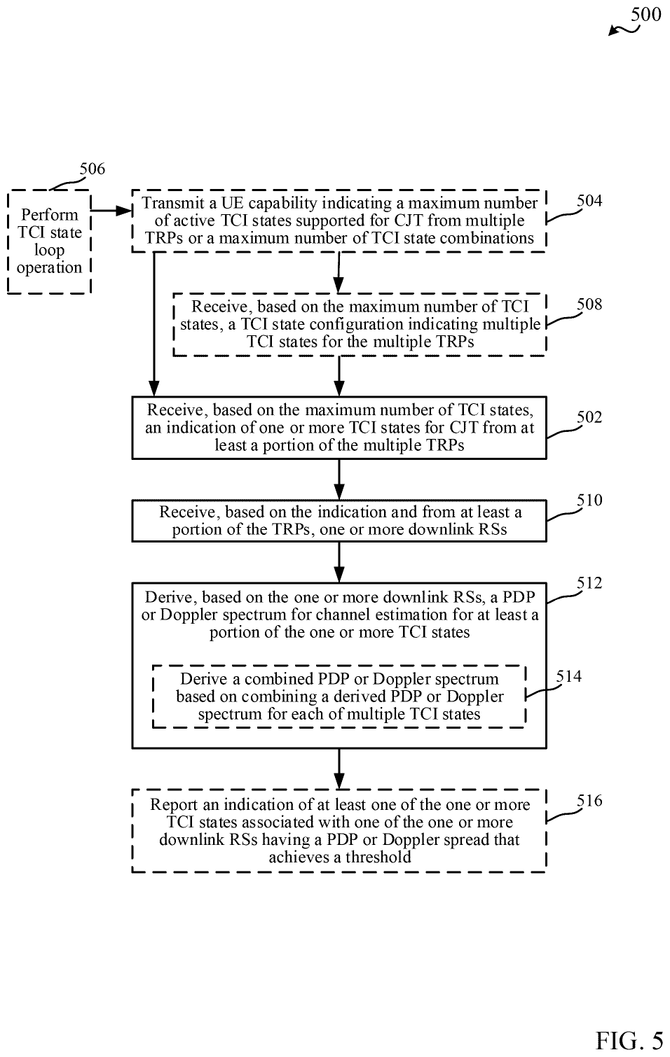

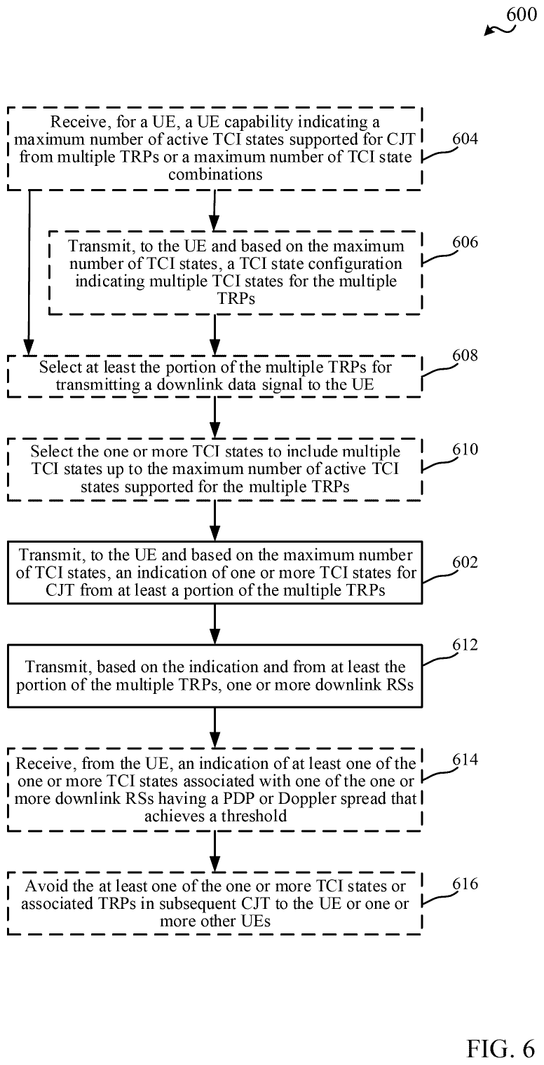

Turning now to FIGS. 3-8, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for managing configuration of number of TCI states, up to a maximum number, for CJT using multiple TRPs, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), reference signal received quality (RSRQ), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a capability indicating component 352 for indicating a capability of a maximum number of active TCI states supported for CJT by multiple TRPs at the UE 104, a TCI state component 354 for receiving and/or managing configuration of one or more TCI states corresponding to the multiple TRPs, and/or a spectrum deriving component 356 for deriving a PDP or Doppler spectrum based on reference signals received for the one or more TCI states in a configuration or otherwise indicated for receiving downlink data signals from a network node, in accordance with aspects described herein.

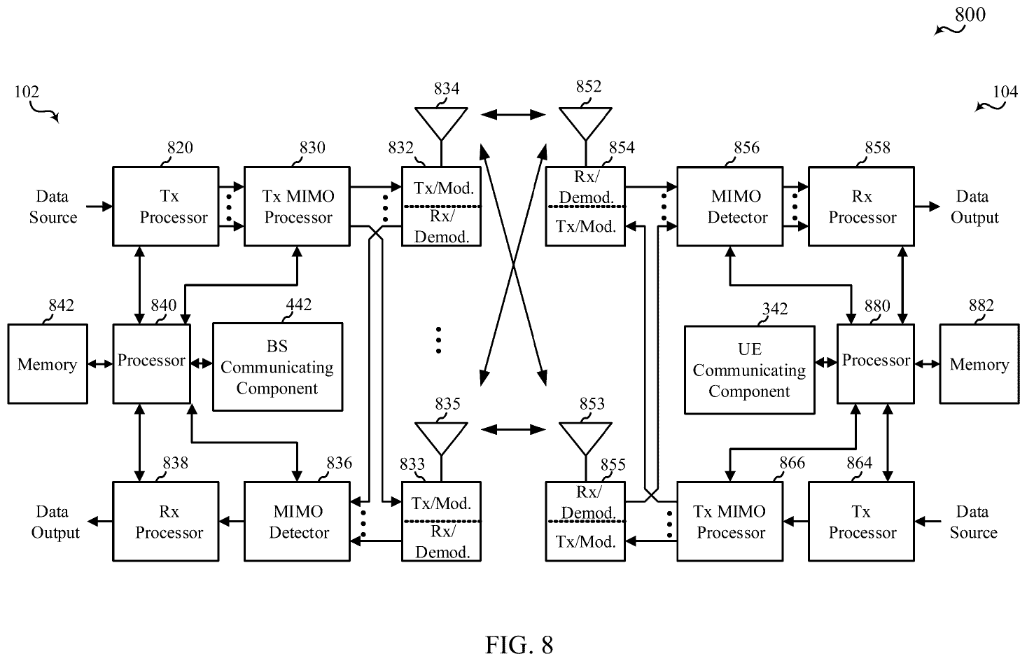

In an aspect, the processor(s) 312 may correspond to one or more of the processors described in connection with the UE in FIG. 8. Similarly, the memory 316 may correspond to the memory described in connection with the UE in FIG. 8.

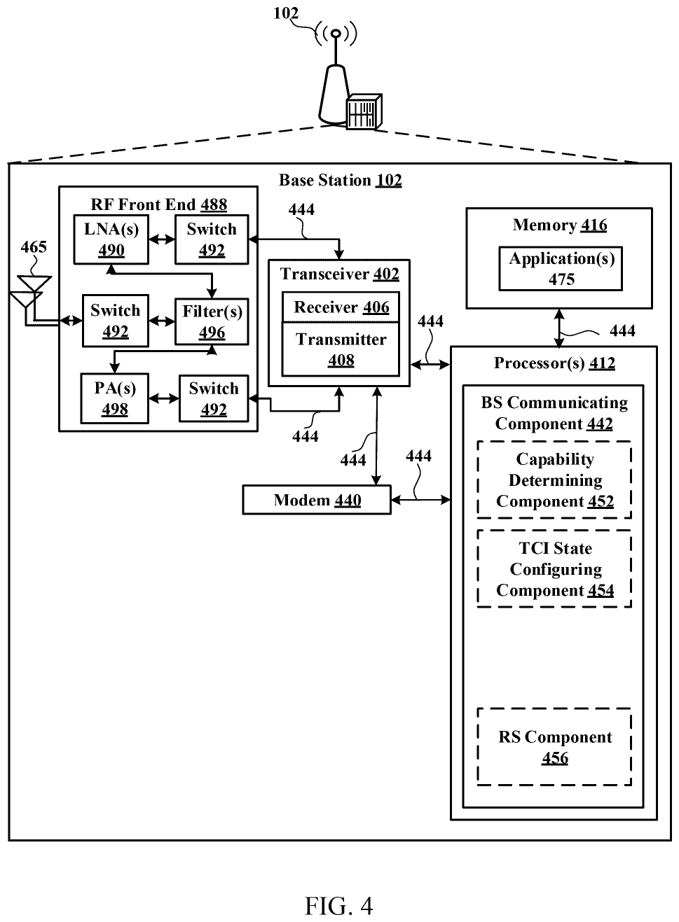

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for configuring a UE with a number of TCI states, up to a maximum number, for CJT using multiple TRPs, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a capability determining component 452 for determining a capability of a UE of a maximum number of active TCI states supported for CJT from multiple TRPs, a TCI state configuring component 454 for configuring TCI states for possible activation or otherwise indicating one or more TCI states for the UE 104 to use in receiving downlink data signals from the base station 102, and/or a reference signal (RS) component 456 for transmitting one or more RSs to facilitate deriving a PDP or Doppler spectrum for channel estimation based on the one or more TCI states, in accordance with aspects described herein.

In an aspect, the processor(s) 412 may correspond to one or more of the processors described in connection with the base station in FIG. 8. Similarly, the memory 416 may correspond to the memory described in connection with the base station in FIG. 8.

FIG. 5 illustrates a flow chart of an example of a method 500 for using or managing a configuration of a number of TCI states for CJT from multiple TRPs, in accordance with aspects described herein. FIG. 6 illustrates a flow chart of an example of a method 600 for configuring a UE for using or managing a configuration of a number of TCI states for CJT from multiple TRPs, in accordance with aspects described herein. In an example, a UE 104 can perform the functions described in method 500 using one or more of the components described in FIGS. 1 and 3, and a network node, such as a base station 102 or gNB, a portion of a disaggregated base station 102 or gNB, etc., can perform the functions described in method 600 using one or more of the components described in FIGS. 1 and 4. Though methods 500 and 600 are described in conjunction with one another for ease of explanation, the methods are not required to be performed in conjunction, and different devices can, or can be configured to, independently perform the different methods.

In method 600, at Block 602, an indication of one or more TCI states for CJT from at least a portion of multiple TRPs can be transmitted to a UE and based on a maximum number of TCI states. In an aspect, TCI state configuring component 454, e.g., in conjunction with processor(s) 412, memory 416, transceiver 402, BS communicating component 442, etc., can transmit, to the UE (e.g., UE 104) and based on the maximum number of TCI states, the indication of one or more TCI states for CJT from at least a portion of multiple TRPs. For example, the UE 104 can be configured to receive a downlink data signal from a number of TRPs using CJT. The UE 104 can be configured to receive the downlink data signal from a maximum number, N, of TRPs (e.g., 4 TRPs in 5G NR), and the network node can select the number of TRPs for transmitting downlink data signals to the UE 104 using CJT. In an example, the network node may select a number, M, of TRPs to use for CJT of the downlink data signal to the UE 104, where M≤N. Each TRP and/or combination of TRPs for CJT can be associated with a number of TCI states, and as such, the number of TCI states that can be configurable for the UE 104 can become large. Accordingly, TCI state configuring component 454 can indicate or configure a reduced number of TCI states for the multiple TRPs (e.g., no more than the maximum number of active TCI states supported by the UE 104 for CJT using multiple TRPs). For example, TCI state configuring component 454 can indicate the one or more TCI states using RRC signaling, media access control (MAC)-control element (CE), downlink control information (DCI) for a downlink data signal (e.g., over a downlink channel, such as physical downlink shared channel (PDSCH)) to be transmitted to the UE 104, etc.

In method 500, at Block 502, an indication of one or more TCI states for CJT from at least a portion of multiple TRPs can be received based on a maximum number of TCI states. In an aspect, TCI state component 354, e.g., in conjunction with processor(s) 312, memory 316, transceiver 302, UE communicating component 342, etc., can receive, based on the maximum number of TCI states, the indication of the one or more TCI states for CJT from at least the portion of the multiple TRPs. For example, TCI state component 354 can receive the indication of the one or more TCI states from the network node in a MAC-CE, DCI for a downlink data signal, etc., as described. In one example, the indicated TCI states can be down-selected from multiple configured TCI states, as described further herein. As such, in one example, TCI state component 354 can receive the indication of the one or more TCI states as an index into a set of configured TCI states. In addition, for example, the one or more TCI states can include a number of TCI states that is no larger than the maximum number of TCI states supported by the UE 104. By specifying the maximum number of TCI states, in this regard, the UE 104 can manage less than a total number of TCI states for all TRPs and/or combinations of multiple TRPs, which can ease processing burden of managing a TCI loop.

In one example, the maximum number of active TCI states supported by the UE 104 for CJT using multiple TRPs can be specified by the wireless communication technology standard (e.g., 5G NR) and accordingly known or stored in memory 416 of the network node. In another example, maximum number of active TCI states supported can be indicated by the UE 104 in UE capability information (e.g., in RRC signaling). In method 600, optionally at Block 604, a UE capability indicating a maximum number of active TCI states supported for CJT from multiple TRPs, or a maximum number of TCI state combinations, can be received for a UE. In an aspect, capability determining component 452, e.g., in conjunction with processor(s) 412, memory 416, transceiver 402, BS communicating component 442, etc., can receive, for the UE (e.g., UE 104), the UE capability indication the maximum number of active TCI states supported for CJT from multiple TRPs or a maximum number of TCI state combinations. Similarly, in method 500, optionally at Block 504, a UE capability indicating a maximum number of active TCI states supported for CJT from multiple TRPs, or a maximum number of TCI state combinations, can be transmitted. In an aspect, capability indicating component 352, e.g., in conjunction with processor(s) 312, memory 316, transceiver 302, UE communicating component 342, etc., can transmit the UE capability indication the maximum number of active TCI states supported for CJT from multiple TRPs or a maximum number of TCI state combinations. In one example, capability indicating component 352 can transmit, and/or capability determining component 452 can receive, the UE capability indication in RRC signaling. In one example, UE capability for maximum number of active TCI states, K, can be smaller than UE capability for maximum number TRPs for DL CJT operation, N.

In an example, the UE capability can additionally or alternatively indicate the maximum number of TCI state combinations or TRP combinations, X, supported by the UE 104. For example, without this capability, the UE can be assumed to support all possible TRP combinations for CJT among K TCI states (e.g., Xₘₐₓ=2^{k}−1 TRP combinations for CJT). In another example, where X<Xₘₐₓ is indicated by the UE 104, the network node can configure \tilde{X}≤X TRP combinations for CJT to the UE 104.

In one example, in method 500, optionally at Block 506, a TCI state loop operation can be performed. In an aspect, UE communicating component 342, e.g., in conjunction with processor(s) 312, memory 316, transceiver 302, etc., can perform the TCI state loop operation (e.g., a tracking loop operation), which may include receiving RSs corresponding to configured TCI states (e.g., as described further herein) and deriving PDP or Doppler for the TCI states. In one example, spectrum deriving component 356 can pre-calculate PDP or Doppler for X TRP combinations for CJT. In this example, capability indicating component 352 can indicate the UE capability as a number of TCI states and a number of TRP combinations for CJT (e.g., K=4 TCI states and X=6 TRP combinations).

In another example, the UE capability can additionally or alternatively indicate {M, X} tuples for {number of TCI states, M, maximum supported number of TRP combinations for CJT, X, with M TCI states}. For example, the UE capability can indicate K=4 TCI states and [{m=1, X=2}, {m=2, x=2}, {m=3, X=2}, {m=4x=1}]. In the above examples, TCI state configuring component 454 can use the indication of the number of supported TRP combinations for CJT to generate the TCI state configuration, to select the portion of the multiple TRPs, or to select the TCI states for the multiple TRPs, as described further herein. For example, TCI state configuring component 454 can generate the TCI state configuration with a number of TRP combinations not to exceed the indicated maximum, or to comply with the maximums indicated in the tuples for each TCI state. In another example, TCI state configuring component 454 can select the portion of the multiple TRPs (e.g., in Block 606) or various combinations of the multiple TRPs not to exceed the indicated maximum, or to comply with the maximums indicated in the tuples for each TCI state. In another example, TCI state configuring component 454 can select the TCI states (e.g., in Block 608) not to exceed the indicated maximum, or to comply with the maximums indicated in the tuples for each TCI state.

In method 600, optionally at Block 606, a TCI state configuration indicating multiple TCI states for the multiple TRPs can be transmitted to the UE and based on the maximum number of TCI states. In an aspect, TCI state configuring component 454, e.g., in conjunction with processor(s) 412, memory 416, transceiver 402, BS communicating component 442, etc., can transmit, to the UE (e.g., UE 104) and based on the maximum number of TCI states, the TCI state configuration indicating the multiple TCI states for the multiple TRPs. In one example, where the network node can activate or indicate one single frequency network (SFN) TCI state associated with a selected M number of TRPs, TCI state configuring component 454 can configure a pool of TCI states where TCI states in the pool can be associated with 1≤Mₖ≤N TRPs, where Mₖ is a number of SSBs from selected TRPs, one from each TRP. In another example, where the network node can activate or indicate per-TRP TCI state, TCI state configuring component 454 can configure a separate TCI state for each single TRP in the multiple TRPs (e.g., one TCI state for each of N TRPs). In another example, where the network node can activate or indicate a per-TRP group TCI state (e.g., by grouping multiple TRPs together to have a single TCI state), TCI state configuring component 454 can configure a separate TCI state for at least one group of TRPs in the multiple TRPs and/or one or more single TRPs.

In method 500, optionally at Block 508, a TCI state configuration indicating multiple TCI states for the multiple TRPs can be received based on the maximum number of TCI states. In an aspect, TCI state configuring component 454, e.g., in conjunction with processor(s) 412, memory 416, transceiver 402, BS communicating component 442, etc., can receive, based on the maximum number of TCI states, the TCI state configuration indicating the multiple TCI states for the multiple TRPs. For example, the TCI state configuration can be configured as described above and further herein, and may indicate a number of TCI states that does not exceed a maximum number of TCI states supported by the UE 104. In an example, receiving the indication at Block 502 may include receiving the indication as an index of one or more TCI states specified in the TCI state configuration, as described.

In method 600, optionally at Block 608, at least the portion of the multiple TRPs can be selected for transmitting a downlink data signal to the UE. In an aspect, TCI state configuring component 454, e.g., in conjunction with processor(s) 412, memory 416, transceiver 402, BS communicating component 442, etc., can select at least the portion of the multiple TRPs for transmitting the downlink data signal to the UE. In an example, TCI state configuring component 454 can select at least the portion of TRPs, M, of the multiple TRPs, N, for transmitting the downlink data signal to the UE 104, where M≤N. In addition, in method 600, optionally at Block 610, the one or more TCI states can be selected to include multiple TCI states up to the maximum number of active TCI states supported for the multiple TRPs. In an aspect, TCI state configuring component 454, e.g., in conjunction with processor(s) 412, memory 416, transceiver 402, BS communicating component 442, etc., can select the one or more TCI states to include multiple TCI states up to the maximum number of activate TCI states supported for the multiple TRPs. In an example, the one or more selected TCI states can correspond to the selected portion of the multiple TRPs. In addition, for example, the indication transmitted at Block 602, and/or received at Block 502, can be based on the one or more selected TCI states that are associated with the selected portion of the multiple TRPs.

In one example described above, where the network node can activate or indicate one SFN TCI state associated with a selected M number of TRPs, TCI state configuring component 454 can select at least the portion, M, of the multiple TRPs, and activate the one SFN TCI state for the portion of the multiple TRPs. In this example, the SFN TCI state TCIₖ can be quasi co-located (QCL) with Mₖ synchronization signal blocks (SSBs) from selected TRPs, one from each TRP. For example, TCIₖ={SSB₀, SSB₁, . . . , SSB_{M}_{_{K}}₋₁}. In an example, RS component 456, as described further herein, can transmit downlink reference signals (e.g., tracking reference signal (TRS)) from the selected TRPs (e.g., as {SSB₀, SSB₁, . . . , SSB_{M}_{ₖ}₋₁}) for the SFN TCI state.

In another example described above, where the network node can activate or indicate per-TRP TCI state for multiple TRP CJT, TCI state configuring component 454 can select at least the portion, M, of the multiple TRPs. In this example, TCI state configuring component 454 can activate or indicate the per-TRP TCI states associated with each of the selected portion of the multiple TRPs.

In another example described above, where the network node can activate or indicate at least one TCI state that is for a group of TRPs (e.g., a per-TRP group TCI state), TCI state configuring component 454 can select at least the portion, M, of the multiple TRPs. In this example, TCI state configuring component 454 can activate or indicate the at least one per-TRP group TCI state and/or one or more addition per-TRP group TCI states or per-TRP TCI states for TRPs that are not grouped. In this example, multiple TRPs can be associated with one TCI state due to TRP grouping for TCI state construction. In one example, BS communicating component 442 can determine to group TRPs for the purpose of sharing a TCI state. For example, BS communicating component 442 can group two or more of the multiple TRPs based on a timing or frequency error between the TRPs being less than a threshold. In any case, grouping TRPs for the purposes of TCI state configuration or management can further reduce the number of TCI states configured for the UE 104.

In method 600, at Block 612, one or more downlink RSs can be transmitted based on the indication and from at least the portion of the multiple TRPs. In an aspect, RS component 456, e.g., in conjunction with processor(s) 412, memory 416, transceiver 402, BS communicating component 442, etc., can transmit, based on the indication of the one or more TCI states and from at least the portion of the multiple TRPs that are selected (e.g., at Block 608), one or more downlink RSs. For example, the downlink RSs can include TRS, SSB, CSI-RS, SRS, etc., and can be transmitted based on each of the one or more TCI states corresponding to the selected portion of the multiple TRPs.

In method 500, at Block 510, one or more downlink RSs can be received based on the indication and from at least a portion of the TRPs. In an aspect, UE communicating component 342, e.g., in conjunction with processor(s) 312, memory 316, transceiver 302, etc., can receive, based on the indication of the one or more TCI states and from at least the portion of the multiple TRPs that are selected (e.g., at Block 608), one or more downlink RSs. For example, the downlink RSs can include TRS, SSB, CSI-RS, SRS, etc., and can be received based on each of the one or more TCI states corresponding to the selected portion of the multiple TRPs.

In method 500, at Block 512, a PDP or Doppler spectrum can be derived for channel estimation for at least a portion of the one or more TCI states based on the one or more downlink RSs. In an aspect, spectrum deriving component 356, e.g., in conjunction with processor(s) 312, memory 316, transceiver 302, UE communicating component 342, etc., can derive, based on the one or more downlink RSs, the PDP or Doppler spectrum for channel estimation for at least a portion of the one or more TCI states.

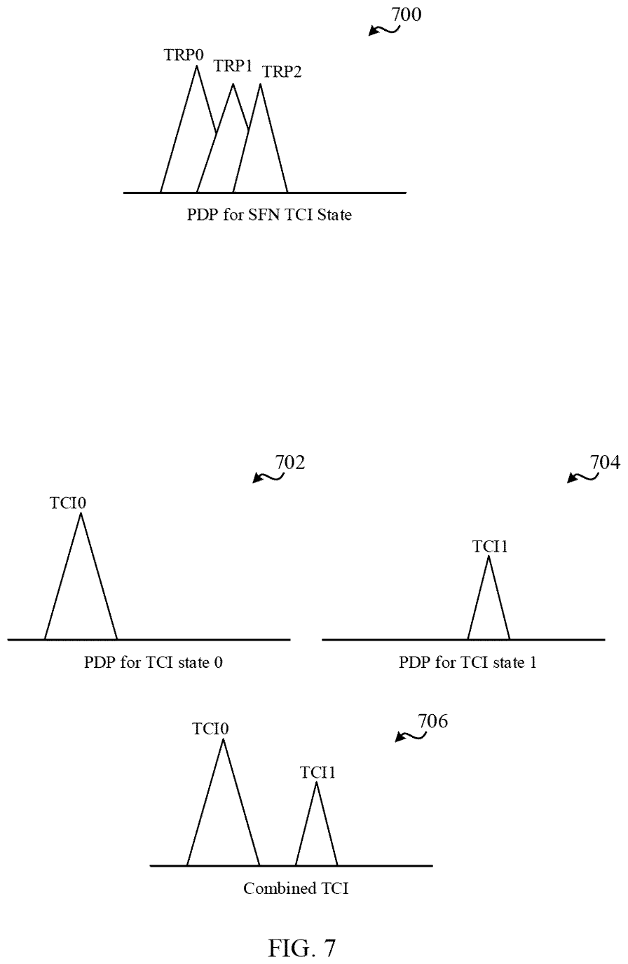

In one example described above, where the network node can activate or indicate one SFN TCI state associated with a selected M number of TRPs, RS component 456 can transmit the one or more downlink RSs (e.g., in a SFN manner from selected TRPs) based on the one SFN TCI state associated with the selected M number of TRPs, and UE communicating component 342 can receive the one or more downlink RSs based on the one SFN TCI state associated with the configuration of the selected M number of TRPs. In this example, spectrum deriving component 356 can use the DL reference RS for the SFN TCI state, and/or can derive the PDP or Doppler for channel estimation from measurement of the SFN RS. An example is shown in FIG. 7.

FIG. 7 illustrates examples of PDP spectrums 700, 702, 704, 706 derived for various TRP or TCI state configurations. In PDP spectrum 700, TRP0, TRP1, and TRP2 transmit the downlink RS as SFN RS, and spectrum deriving component 356 can derive the PDP or Doppler spectrum of the combined SFN RS as received, for SFN TCI state.

In another example described above, where the network node can activate or indicate per-TRP TCI state for multiple TRP CJT, RS component 456 can transmit the one or more downlink RSs separately from each of the selected M number of TRPs, and UE communicating component 342 can receive the downlink RSs separately from each of the selected M number of TRPs. In this example, spectrum deriving component 356 can derive a combined PDP or Doppler spectrum, as shown in FIG. 7.

In this example, UE communicating component 342 can receive the downlink RS for TCI0, and spectrum deriving component 356 can derive the PDP or Doppler spectrum at 702. UE communicating component 342 can also receive the downlink RS for TCI1, and spectrum deriving component 356 can derive the PDP or Doppler spectrum at 704. In this example, spectrum deriving component 356 can combine the derived PDP or Doppler spectrums to derive the combined PDP or Doppler spectrum at 706.

In this regard, for example, in deriving the PDP or Doppler spectrum at Block 512, optionally at Block 514, a combined PDP or Doppler spectrum can be derived based on combining a derived PDP or Doppler spectrum for each of multiple TCI states. In an aspect, spectrum deriving component 356, e.g., in conjunction with processor(s) 312, memory 316, transceiver 302, UE communicating component 342, etc., can derive the combined PDP or Doppler spectrum based on combining the derived PDP or Doppler spectrum for each of multiple TCI states (e.g., as derived for each of multiple RSs received that correspond to the multiple TCI states).

In another example described above, where the network node can activate or indicate at least one TCI state that is for a group of TRPs (e.g., a per-TRP group TCI state), RS component 456 can transmit the downlink RSs related to a TCI state for a group of TRPs as a QCL reference for the multiple TRPs in the group. In one example, RS component 456 can transmit the downlink RS as a QCL reference from one TRP in the group. In another example, RS component 456 can transmit the downlink RS as a QCL reference in a SFN manner from all (or multiple) TRPs in the group. In either example, UE communicating component 342 can receive the downlink RS, and spectrum deriving component 356 can use the downlink RS to derive the PDP or Doppler spectrum for the TCI state for the group of TRPs. In this example, RS component 456 can transmit, and UE communicating component 342 can receive, additional RSs for other per-TRP or per-TRP group TCI states, and spectrum deriving component 356 can use the downlink RS to derive the PDP or Doppler spectrum for the TCI state for the associated TCI state.

In an example, deriving the PDP and Doppler spectrum can enable the UE (e.g., via UE communicating component 342) to perform channel estimation of a downlink data signal that can be received based on DCI or other scheduling from the network node. As described, in an example, the DCI can indicate the TCI state (e.g., the one or more TCI states) used to transmit the downlink data signal or the TCI state(s) associated with multiple TRPs used to transmit the downlink data signal. Spectrum deriving component 356 can accordingly derive the PDP or Doppler spectrum for an associated downlink RS received for the downlink data signal in order to perform channel estimation for the downlink data signal.

In an example, a certain TRP or combination of TRPs may have a timing or frequency (or other synchronization) difference, with the UE 104 or between the TRPs, that exceeds a threshold, and thus CJT from such TRPs or combinations of TRPs may have a timing or frequency (or other synchronization) error that exceeds a threshold or otherwise degrades downlink performance. As such, in some examples, undesirable TRPs or combinations of TRPs or associated TCI states can be reported to the network node. For example, the UE 104 can detect such TRPs or combinations of TRPs based on detecting that the PDP or Doppler spread associated with a certain TCI state exceeds (or meets) a threshold.

Accordingly, in method 500, optionally at Block 516, an indication of at least one of the one or more TCI states associated with one of the one or more downlink RSs having a PDP or Doppler spread that achieves a threshold can be reported. In an aspect, spectrum deriving component 356, e.g., in conjunction with processor(s) 312, memory 316, transceiver 302, UE communicating component 342, etc., can report (e.g., to the network node) the indication of at least one of the one or more TCI states associated with one of the one or more downlink RSs having a PDP or Doppler spread that achieves the threshold. For example, spectrum deriving component 356 can compare the spectrum derived for the TCI state, e.g., at Block 512 or 514, to the threshold, and can report the TCI state to the network node where the PDP or Doppler spread of the TCI state exceeds (or meets) the threshold. For example, the UE 104 can be configured with the threshold, by the network node, by instructions in memory 316 based on a wireless communication technology standard, etc. In another example, spectrum deriving component 356 can compare the spectrum derived for a pair (or other multiple) of TCI states, e.g., at Block 512 or 514, and can report the pair of TCI states to the network node where a difference between the PDP or Doppler spread of the pair of TCI states exceeds (or meets) a threshold

In addition, in an example, spectrum deriving component 356 can report the TCI state or pair of TCI states using uplink control channel signaling, RRC or other static or semi-static signaling, etc. In one example, spectrum deriving component 356 can report the indication in CSI feedback for multiple TRPs in FDD band. In one specific example, spectrum deriving component 356 can deprioritize such TCI state(s) (e.g., a TCI state related to a TRP or combination of TRPs or a pair of TCI states with large timing or frequency error) when selecting TCI states for CJT CSI feedback. The deprioritization can indicate that the TCI state(s) have undesirable PDP or Doppler spread.

In method 600, at Block 614, an indication of at least one of the one or more TCI states associated with one of the one or more downlink RSs having a PDP or Doppler spread that achieves a threshold can be received from the UE. In an aspect, TCI state configuring component 454, e.g., in conjunction with processor(s) 412, memory 416, transceiver 402, BS communicating component 442, etc., can receive, from the UE (e.g., UE 104), the indication of at least one of the one or more TCI states associated with one of the one or more downlink RSs having a PDP or Doppler spread that achieves the threshold. In an example, TCI state configuring component 454 can use this indication to identify TCI states associated with a TRP or combination of TRPs with large intra-group timing or frequency error, and can accordingly avoid using this TRP or associating the combination of TRPs in a group for CJT to the UE 104 and/or subsequent CJT to one or more other UEs. In another example, TCI state configuring component 454 can use this indication to identify a pair (or other multiple) of TCI states having a large intra-group timing or frequency difference between them, and can accordingly avoid configuring or activating these TCI states for CJT to the UE 104 and/or subsequent CJT to one or more other UEs.

In method 600, at Block 616, the at least one of the one or more TCI states or associated TRPs can be avoided in subsequent CJT to the UE or one or more other UEs. In an aspect, TCI state configuring component 454, e.g., in conjunction with processor(s) 412, memory 416, transceiver 402, BS communicating component 442, etc., can avoid the at least one of the one or more TCI states or associated TRPs in subsequent CJT to the UE or one or more other UEs. For example, TCI state configuring component 454 can avoid the reported TCI states and/or the associated combination of TRPs in selecting at least the portion of the multiple TRPs at Block 608 and/or in selecting the one or more TCI states at Block 610.

FIG. 8 is a block diagram of a MIMO communication system 800 including a base station 102 and a UE 104. The MIMO communication system 800 may illustrate aspects of the wireless communication access network 100 described with reference to FIG. 1. The base station 102 may be an example of aspects of the base station 102 described with reference to FIG. 1. The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 820 may receive data from a data source. The transmit processor 820 may process the data. The transmit processor 820 may also generate control symbols or reference symbols. A transmit MIMO processor 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1 and 3. At the UE 104, the UE antennas 852 and 853 may receive the DL signals from the base station 102 and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor 858 may process (e.g., demodulate, deinterleave, and decode) the detected symbols, providing decoded data for the UE 104 to a data output, and provide decoded control information to a processor 880, or memory 882.

The processor 880 may in some cases execute stored instructions to instantiate a UE communicating component 342 (see e.g., FIGS. 1 and 3).

On the uplink (UL), at the UE 104, a transmit processor 864 may receive and process data from a data source. The transmit processor 864 may also generate reference symbols for a reference signal. The symbols from the transmit processor 864 may be precoded by a transmit MIMO processor 866 if applicable, further processed by the modulator/demodulators 854 and 855 (e.g., for single carrier-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor 838. The receive processor 838 may provide decoded data to a data output and to the processor 840 or memory 842.

The processor 840 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 800. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.

Aspect 1 is a method for wireless communication at a UE including transmitting, to a network node, a UE capability indicating a maximum number of active TCI states supported for CJT from multiple TRPs, receiving, from the network node and based on the maximum number of TCI states, an indication of one or more TCI states for CJT from at least a portion of the multiple TRPs, receiving, based on the indication and from at least the portion of the multiple TRPs, one or more downlink reference signals, and deriving, based on the one or more downlink reference signals, a PDP or Doppler spectrum for channel estimation for at least a portion of the one or more TCI states.

In Aspect 2, the method of Aspect 1 includes where the indication is received in DCI, MAC-CE signaling, or RRC signaling.

In Aspect 3, the method of any of Aspects 1 or 2 includes where the indication includes one TCI state for at least the portion of the multiple TRPs including two or more TRPs from the multiple TRPs.

In Aspect 4, the method of Aspect 3 includes where the one TCI state is quasi co-located with the downlink reference signals from each TRP in the portion of the multiple TRPs.

In Aspect 5, the method of any of Aspects 3 or 4 includes receiving, from the network node and based on the maximum number of TCI states, a TCI state configuration specifying a pool of TCI states each associated with a combination of at least a portion of the multiple TRPs, where the indication of the one or more TCI states corresponds to the TCI state configuration.

In Aspect 6, the method of any of Aspects 1 to 5 includes receiving, from the network node and based on the maximum number of TCI states, a TCI state configuration specifying one TCI state for each TRP in a portion of the multiple TRPs including the one or more TCI states.

In Aspect 7, the method of Aspect 6 includes performing a tracking loop operation for the one TCI state for each TRP.

In Aspect 8, the method of any of Aspects 6 or 7 includes where the indication of one or more TCI states includes an indication of multiple TCI states each corresponding to one of at least the portion of the multiple TRPs selected for CJT transmission, and where deriving the PDP or Doppler spectrum includes deriving a combined PDP or Doppler spectrum for reception of a downlink data signal from at least the portion of the multiple TRPs that are selected for CJT transmission at least in part by combining a derived PDP or Doppler spectrum for each of the multiple TCI states.

In Aspect 9, the method of any of Aspects 1 to 8 includes receiving, from the network node and based on the maximum number of TCI states, a TCI state configuration specifying multiple TCI states including the one or more TCI states, where the one or more TCI states includes one TCI state for a group of TRPs including one or more TRPs from the multiple TRPs.

In Aspect 10, the method of Aspect 9 includes where the multiple TCI states include at least one other TCI state for another group of TRPs including one or more other TRPs from the multiple TRPs.

In Aspect 11, the method of any of Aspects 9 or 10 includes where the one TCI state for at least one group of TRPs is quasi co-located with the downlink reference signals from each TRP in the at least one group of TRPs.

In Aspect 12, the method of any of Aspects 9 to 11 includes where the indication of one or more TCI states includes an indication of at least a portion of the multiple TCI states including the one TCI state for the group of TRPs, and where deriving the PDP or Doppler spectrum includes deriving a combined PDP or Doppler spectrum for reception of a downlink data signal from at least the portion of the multiple TRPs that are selected for CJT transmission at least in part by combining a derived PDP or Doppler spectrum for each of the multiple TCI states including the one TCI state for the at least one group of TRPs.

In Aspect 13, the method of any of Aspects 1 to 12 includes where the maximum number of TCI states is less than a maximum number of TRPs for CJT transmission indicated in a different UE capability.

In Aspect 14, the method of any of Aspects 1 to 13, includes where the UE capability also indicates a maximum number of supported TCI state combinations supported for CJT, and where the configuration is further based on the maximum number of supported TCI state combinations.

In Aspect 15, the method of Aspect 14 includes where the UE capability also indicates one or more tuples of number of TCI states and maximum supported number of TCI state combinations with the number of TCI states, and where the configuration is based on the one or more tuples.

In Aspect 16, the method of any of Aspects 1 to 15 includes reporting, to the network node, a first indication of at least one of the one or more TCI states associated with one of the one or more downlink reference signals having a PDP spread or Doppler spread that achieves a threshold.

In Aspect 17, the method of any of Aspects 1 to 16 includes reporting, to the network node, an indication of pairs of TCI states associated with pairs of downlink reference signals having a difference in PDP spread or Doppler spread that achieves a threshold.

In Aspect 18, the method of any of Aspects 1 to 17 includes transmitting, to the network node, CSI feedback for the one or more TCI states, and deprioritizing the CSI feedback for a portion of multiple TCI states associated with one of the one or more downlink reference signals having a difference in PDP spread or Doppler spread that achieves a threshold.

Aspect 19 is a method for wireless communication at a network node including receiving, for a UE, a UE capability indicating a maximum number of active TCI states supported for CJT from multiple TRPs, transmitting, to the UE and based on the maximum number of TCI states, an indication of one or more TCI states for CJT from at least a portion of the multiple TRPs, and transmitting, based on the indication and from at least the portion of the multiple TRPs, one or more downlink reference signals.

In Aspect 20, the method of Aspect 19 includes where the indication is transmitted in DCI, MAC-CE signaling, or RRC signaling.

In Aspect 21, the method of any of Aspects 19 or 20 includes where the indication includes one TCI state for at least the portion of the multiple TRPs including two or more TRPs from the multiple TRPs.

In Aspect 22, the method of Aspect 21 includes where the one TCI state is quasi co-located with the downlink reference signals from each TRP in the portion of the multiple TRPs.

In Aspect 23, the method of Aspect 22 includes where transmitting the one or more downlink reference signals from each TRP in the portion of multiple TRPs includes transmitting the one or more downlink reference signals in a SFN manner.

In Aspect 24, the method of any of Aspects 21 to 23 includes transmitting, to the UE and based on the maximum number of TCI states, a TCI state configuration specifying a pool of TCI states each associated with a combination of at least a portion of the multiple TRPs, where the indication of the one or more TCI states corresponds to the TCI state configuration.

In Aspect 25, the method of any of Aspects 19 to 24 includes transmitting, to the UE and based on the maximum number of TCI states, a TCI state configuration specifying one TCI state for each TRP of the multiple TRPs including the one or more TCI states.

In Aspect 26, the method of Aspect 25 includes selecting at least the portion of the multiple TRPs for transmitting a downlink data signal to the UE, where the indication of one or more TCI states includes an indication of multiple TCI states each corresponding to one of at least the portion of the multiple TRPs selected for CJT transmission.

In Aspect 27, the method of any of Aspects 19 to 26 includes transmitting, to the UE and based on the maximum number of TCI states, a TCI state configuration specifying multiple TCI states including the one or more TCI states, where the one or more TCI states includes one TCI state for a group of TRPs including one or more TRPs from the multiple TRPs.

In Aspect 28, the method of Aspect 27 includes selecting at least the portion of the multiple TRPs, including the group of TRPs, for transmitting a downlink data signal to the UE, where the indication of one or more TCI states includes an indication of multiple TCI states including the at least one TCI state for the group of TRPs.

In Aspect 29, the method of any of Aspects 27 or 28 includes where the multiple TCI states include at least one other TCI state for another group of TRPs including one or more other TRPs from the multiple TRPs.

In Aspect 30, the method of any of Aspects 27 to 29 includes where the one TCI state for at least one group of TRPs is quasi co-located with the downlink reference signals from each TRP in the at least one group of TRPs.

In Aspect 31, the method of any of Aspects 27 to 30 includes selecting at least the portion of the multiple TRPs for transmitting a downlink data signal to the UE, where the indication of one or more TCI states includes an indication of multiple TCI states each corresponding to one of at least the portion of the multiple TRPs selected for CJT transmission.

In Aspect 32, the method of any of Aspects 19 to 31 includes where the maximum number of TCI states is less than a maximum number of TRPs for CJT transmission indicated in a different UE capability.

In Aspect 33, the method of Aspect 32 includes selecting the one or more TCI states to include multiple TCI states up to the maximum number of active TCI states for the maximum number of TRPs.

In Aspect 34, the method of any of Aspects 19 to 33 includes where the UE capability also indicates a maximum number of supported TCI state combinations supported for CJT, and where the configuration is further based on the maximum number of supported TCI state combinations.

In Aspect 35, the method of Aspect 34 includes transmitting, to the UE, a configuration indicating a number of TCI state combinations to which the one or more TCI states correspond.

In Aspect 36, the method of any of Aspects 34 or 35 includes where the UE capability also indicates one or more tuples of number of TCI states and maximum supported number of TRP combinations with the number of TCI states, and where the configuration is based on the one or more tuples.

In Aspect 37, the method of any of Aspects 19 to 36 includes receiving, from the UE, an indication of at least one of the one or more TCI states associated with one of the one or more downlink reference signals having a PDP spread or Doppler spread that achieves a threshold, and selecting a subset of at least the portion of the multiple TRPs for transmitting a downlink data signal to the UE or one or more other UEs including avoiding a combination of TRPs associated with the at least one of the one or more TCI states.

In Aspect 38, the method of any of Aspects 19 to 37 includes receiving, from the UE, an indication of pairs of TCI states associated with pairs of downlink reference signals having a difference in PDP spread or Doppler spread that achieves a threshold; and selecting a subset of at least the portion of the multiple TRPs for transmitting a downlink data signal to the UE or one or more other UEs including avoiding pairs of TCI states.

Aspect 39 is an apparatus for wireless communication including a processor, memory coupled with the processor, and instructions stored in the memory and operable, when executed by the processor, to cause the apparatus to perform any of the methods of Aspects 1 to 38.

Aspect 40 is an apparatus for wireless communication including means for performing any of the methods of Aspects 1 to 38.

Aspect 41 is a computer-readable medium including code executable by one or more processors for wireless communications, the code including code for performing any of the methods of Aspects 1 to 38.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a processor;
memory coupled with the processor; and
instructions stored in the memory and operable, when executed by the processor, cause the apparatus to:
transmit, to a network node, a user equipment (UE) capability indicating a maximum number of active transmission configuration indicator (TCI) states supported for coherent joint transmission (CJT) from multiple transmission reception points (TRPs);
receive, from the network node and based on the maximum number of TCI states, an indication of one or more TCI states for CJT from at least a portion of the multiple TRPs;
receive, based on the indication and from at least the portion of the multiple TRPs, one or more downlink reference signals; and
derive, based on the one or more downlink reference signals, a power delay profile (PDP) or Doppler spectrum for channel estimation for at least a portion of the one or more TCI states.

2. The apparatus of claim 1, wherein the indication is received in downlink control information (DCI), media access control (MAC)-control element (CE) signaling, or radio resource configuration (RRC) signaling.

3. The apparatus of claim 1, wherein the indication includes one TCI state for at least the portion of the multiple TRPs including two or more TRPs from the multiple TRPs.

4. The apparatus of claim 3, wherein the one TCI state is quasi co-located with the downlink reference signals from each TRP in the portion of the multiple TRPs.

5. The apparatus of claim 3, wherein the instructions, when executed by the processor, cause the apparatus to receive from the network node and based on the maximum number of TCI states, a TCI state configuration specifying a pool of TCI states each associated with a combination of at least a portion of the multiple TRPs, wherein the indication of the one or more TCI states corresponds to the TCI state configuration.

6. The apparatus of claim 1, wherein the instructions, when executed by the processor, cause the apparatus to receive, from the network node and based on the maximum number of TCI states, a TCI state configuration specifying one TCI state for each TRP in a portion of the multiple TRPs including the one or more TCI states.

7. The apparatus of claim 6, wherein the instructions, when executed by the processor, cause the apparatus to perform a tracking loop operation for the one TCI state for each TRP.

8. The apparatus of claim 6, wherein the indication of one or more TCI states includes an indication of multiple TCI states each corresponding to one of at least the portion of the multiple TRPs selected for CJT transmission, and
wherein the instructions, when executed by the processor, cause the apparatus to derive a combined PDP or Doppler spectrum for reception of a downlink data signal from at least the portion of the multiple TRPs that are selected for CJT transmission at least in part by combining a derived PDP or Doppler spectrum for each of the multiple TCI states.

9. The apparatus of claim 1, wherein the instructions, when executed by the processor, cause the apparatus to receive, from the network node and based on the maximum number of TCI states, a TCI state configuration specifying multiple TCI states including the one or more TCI states, wherein the one or more TCI states includes one TCI state for a group of TRPs including one or more TRPs from the multiple TRPs.

10. The apparatus of claim 9, wherein the multiple TCI states include at least one other TCI state for another group of TRPs including one or more other TRPs from the multiple TRPs.

11. The apparatus of claim 9, wherein the one TCI state for at least one group of TRPs is quasi co-located with the downlink reference signals from each TRP in the at least one group of TRPs.

12. The apparatus of claim 9, wherein the indication of one or more TCI states includes an indication of at least a portion of the multiple TCI states including the one TCI state for the group of TRPs, and
wherein the instructions, when executed by the processor, cause the apparatus to derive a combined PDP or Doppler spectrum for reception of a downlink data signal from at least the portion of the multiple TRPs that are selected for CJT transmission at least in part by combining a derived PDP or Doppler spectrum for each of the multiple TCI states including the one TCI state for the at least one group of TRPs.

13. The apparatus of claim 1, wherein the maximum number of TCI states is less than a maximum number of TRPs for CJT transmission indicated in a different UE capability.

14. The apparatus of claim 1, wherein the UE capability also indicates a maximum number of supported TCI state combinations supported for CJT, and wherein the configuration is further based on the maximum number of supported TCI state combinations.

15. The apparatus of claim 14, wherein the UE capability also indicates one or more tuples of number of TCI states and maximum supported number of TCI state combinations with the number of TCI states, and wherein the configuration is based on the one or more tuples.

16. The apparatus of claim 1, wherein the instructions, when executed by the processor, cause the apparatus to report, to the network node, a first indication of at least one of the one or more TCI states associated with one of the one or more downlink reference signals having a PDP spread or Doppler spread that achieves a threshold.

17. The apparatus of claim 1, wherein the instructions, when executed by the processor, cause the apparatus to report, to the network node, an indication of pairs of TCI states associated with pairs of downlink reference signals having a difference in PDP spread or Doppler spread that achieves a threshold.

18. The apparatus of claim 1, wherein the instructions, when executed by the processor, cause the apparatus to:
transmit, to the network node, channel state information (CSI) feedback for the one or more TCI states; and
deprioritize the CSI feedback for a portion of multiple TCI states associated with one of the one or more downlink reference signals having a difference in PDP spread or Doppler spread that achieves a threshold.

19. An apparatus for wireless communication, comprising:
a processor;
memory coupled with the processor; and
instructions stored in the memory and operable, when executed by the processor, cause the apparatus to:
receive, for a user equipment (UE), a UE capability indicating a maximum number of active transmission configuration indicator (TCI) states supported for coherent joint transmission (CJT) from multiple transmission reception points (TRPs);
transmit, to the UE and based on the maximum number of TCI states, an indication of one or more TCI states for CJT from at least a portion of the multiple TRPs; and
transmit, based on the indication and from at least the portion of the multiple TRPs, one or more downlink reference signals.

20. The apparatus of claim 19, wherein the indication is transmitted in downlink control information (DCI), media access control (MAC)-control element (CE) signaling, or radio resource configuration (RRC) signaling.

21. The apparatus of claim 19, wherein the indication includes one TCI state for at least the portion of the multiple TRPs including two or more TRPs from the multiple TRPs.

22. The apparatus of claim 21, wherein the one TCI state is quasi co-located with the downlink reference signals from each TRP in the portion of the multiple TRPs.

23. The apparatus of claim 22, wherein the instructions, when executed by the processor, cause the apparatus to transmit the one or more downlink reference signals from each TRP in the portion of multiple TRPs in a single frequency network (SFN) manner.

24. The apparatus of claim 21, wherein the instructions, when executed by the processor, cause the apparatus to transmit, to the UE and based on the maximum number of TCI states, a TCI state configuration specifying a pool of TCI states each associated with a combination of at least a portion of the multiple TRPs, wherein the indication of the one or more TCI states corresponds to the TCI state configuration.

25. The apparatus of claim 19, wherein the instructions, when executed by the processor, cause the apparatus to transmit, to the UE and based on the maximum number of TCI states, a TCI state configuration specifying one TCI state for each TRP of the multiple TRPs including the one or more TCI states.

26. The apparatus of claim 19, wherein the instructions, when executed by the processor, cause the apparatus to transmit, to the UE and based on the maximum number of TCI states, a TCI state configuration specifying multiple TCI states including the one or more TCI states, wherein the one or more TCI states includes one TCI state for a group of TRPs including one or more TRPs from the multiple TRPs.

27. A method for wireless communication at a user equipment (UE), comprising:
transmitting, to a network node, a UE capability indicating a maximum number of active transmission configuration indicator (TCI) states supported for coherent joint transmission (CJT) from multiple transmission reception points (TRPs);
receiving, from the network node and based on the maximum number of TCI states, an indication of one or more TCI states for CJT from at least a portion of the multiple TRPs;
receiving, based on the indication and from at least the portion of the multiple TRPs, one or more downlink reference signals; and
deriving, based on the one or more downlink reference signals, a power delay profile (PDP) or Doppler spectrum for channel estimation for at least a portion of the one or more TCI states.

28. The method of claim 27, wherein the indication is received in downlink control information (DCI), media access control (MAC)-control element (CE) signaling, or radio resource configuration (RRC) signaling.

29. A method for wireless communication at a network node, comprising:
receiving, for a user equipment (UE), a UE capability indicating a maximum number of active transmission configuration indicator (TCI) states supported for coherent joint transmission (CJT) from multiple transmission reception points (TRPs);
transmitting, to the UE and based on the maximum number of TCI states, an indication of one or more TCI states for CJT from at least a portion of the multiple TRPs; and
transmitting, based on the indication and from at least the portion of the multiple TRPs, one or more downlink reference signals.

30. The method of claim 29, wherein the indication is transmitted in downlink control information (DCI), media access control (MAC)-control element (CE) signaling, or radio resource configuration (RRC) signaling.
